(19) United States
(12) Patent Application Publication
(10) Pub. No.: US 2022/0388696 A1
(43) Pub. Date: Dec. 8, 2022

(54) DEVICE FOR DAMPING DOCKING TO A SATELLITE

(71) Applicant: AIRBUS DEFENCE AND SPACE SAS, Toulouse Cedex 4 (FR)

(72) Inventors: Florent TAJAN, Toulouse Cedex 4 (FR); Thierry BLAIS, Toulouse Cedex 4 (FR)

(21) Appl. No.: 17/787,217

(22) PCT Filed: Dec. 17, 2020
(86) PCT No.: PCT/FR2020/052491

§ 371 Date: Jun. 17, 2022

(30) Foreign Application Priority Data
Dec. 20, 2019 (FR) 19 15179

(51) Int. Cl. B64G 1/64

(52) U.S. Cl. CPC B64G 1/646; B64G 1/641

(57) ABSTRACT

A device for docking with a satellite including: a mobile, satellite receiving platform (10), suitable for resting against a protruding element of the satellite, a device for capturing the protruding element, and a device (20) for damping and positioning the receiving platform, including: a set (21) of link arms (210) connecting the satellite receiving platform to a member that is fixed relative to a spacecraft carrying the docking device, the set of link arms being suitable for enabling the platform to move in six degrees of freedom, and a set of magnetic dampers (25), suitable for damping the contact between the satellite and the mobile receiving platform in proportion to the relative speed between the satellite and the mobile receiving platform. A method for docking and undocking this device to/from a satellite.

### TECHNICAL FIELD

This application relates to a device for docking a spacecraft to a satellite, including a satellite that does not comprise specific equipment dedicated to this purpose. It also relates to a method for docking and undocking that is implemented with such a device.

### PRIOR ART

To be able to refuel a satellite with propellant when it is in operation, or to be able to move a satellite from one orbit to another, it is necessary to be able to attach a towing or refueling spacecraft to the satellite in a manner which does not interfere with the mission of the satellite, meaning it does not modify the position and orientation of the satellite. This is particularly critical, for example, for telecommunications satellites in geostationary orbit, which must not be subjected to any movement around their operating attitude.

This implies that the contact between the spacecraft and the satellite is made at the lowest possible relative speed, ideally zero, and with the lowest possible contact forces on the satellite, ideally zero.

However, satellites currently in operation do not comprise any equipment specifically dedicated to docking with a towing or refueling spacecraft.

### SUMMARY

The aim of the invention is to provide a device for docking a towing or refueling spacecraft to a satellite not having any equipment intended for this purpose, which does not affect the attitude of the satellite during docking.

In this respect, the invention proposes a docking device for docking to a satellite comprising a protruding element on an external wall, the docking device being suitable for being mounted on a towing or refueling spacecraft and being characterized in that it comprises:

a mobile receiving platform for a satellite, suitable for resting against the protruding element of the satellite,
a capture device for capturing the protruding element of the satellite, suitable for keeping the protruding element in contact against the receiving platform, and
a device for damping and positioning the receiving platform, comprising:

a set of link arms connecting the satellite receiving platform to a member that is fixed relative to the spacecraft, the set of link arms being suitable for enabling the receiving platform to move in six degrees of freedom relative to the spacecraft, and

a set of magnetic dampers, suitable for damping the contact between the satellite and the mobile receiving platform in proportion to the relative speed between the satellite and the mobile receiving platform.

In one embodiment, each link arm is articulated, and the set of magnetic dampers comprises a rotatable magnetic damper per each link arm.

Each articulated arm may comprise two rods, a first rod comprising a first end connected to the receiving platform by a first spherical connection, and a second end connected to the second rod by a second spherical connection, the second rod being rotatable relative to the spacecraft about an axis.

Each magnetic damper may comprise a stator fixedly mounted relative to the spacecraft and a rotor rotatable relative to the stator, and the second rod of each arm is suitable for rotating the rotor of the magnetic damper of the arm.

The second rod may rotate the rotor of the magnetic damper via a reduction gear suitable for multiplying the speed of rotation of the second rod relative to the stator of the magnetic damper by a factor greater than 10.

In one embodiment, the docking device further comprises, for each articulated arm, a sensor for sensing the angular position of the second portion of the arm.

In one embodiment, the rotary magnetic dampers are distributed in a circular arrangement, the axes of rotation of the dampers extending radially.

In one embodiment, the docking device further comprises an electronic circuit for controlling the magnetic dampers, suitable for controlling the magnetic dampers according to three modes which include:

a damper mode, in which movement of the link arm is damped by dissipation of kinetic energy via eddy current,

an actuator mode, making it possible to control movement of the link arm, and

a free mode, in which movement of the link arm does not cause any damping.

In one embodiment, the device for damping and positioning the receiving platform further comprises a connecting platform for connection to the spacecraft, suitable for being assembled to said craft, and the set of articulated arms connects the receiving platform to the connecting platform.

In one embodiment, the capture device comprises a set of retaining rods mounted on the receiving platform, and comprising at least six bearing points against a protruding element of the satellite, and an actuator suitable for bringing the bearing points of the set of retaining rods to bear against the protruding element of the satellite.

In one embodiment, the set of retaining rods comprises six rods distributed circularly around the periphery of the receiving platform, each retaining rod being mounted so as to rotate about a tangential axis, and the actuator comprises an actuation system with pulleys and belts that is suitable for enabling simultaneous rotation of the rods towards the center of the receiving platform.

In one embodiment, the docking device further comprises a locking device suitable for maintaining a rigid connection between the docking device and the protruding element of the satellite.

The present document also relates to a method for docking a towing or refueling spacecraft comprising a docking device according to the above description, to a satellite comprising a protruding element such as a nozzle of a liquid apogee engine or a launcher interface ring, the method comprising the steps of:

moving the towing or refueling spacecraft towards the satellite such that the receiving platform is positioned substantially opposite the protruding element,

once contact has been established between the protruding element of the satellite and the receiving platform, damping the kinetic energy from contact, by means of the device for damping and positioning the receiving platform,

during damping, capturing the protruding element of the satellite,

once damping is complete, adjusting the relative positioning of the satellite and the towing or refueling spacecraft, and

locking the connection between the satellite and the towing or refueling spacecraft.

The present document also relates to a method for undocking a towing or refueling spacecraft docked to a satellite by implementing the method according to the preceding description, comprising:

unlocking the connection between the satellite and the towing or refueling spacecraft,

moving the receiving platform by means of the device for damping and positioning so as to move the receiving platform away from the connecting platform,

actuating the capture device so as to release the satellite, and

retracting the receiving platform by means of the device for damping and positioning so as to bring the receiving platform closer to the connecting platform.

The present document also relates to a method for controlling a towing or refueling spacecraft from a ground station, in order to implement a method for docking or undocking in orbit according to the above description.

The proposed invention makes it possible to dock a towing or refueling spacecraft to a satellite by capturing the launcher interface ring or a nozzle of a liquid apogee engine of the satellite. As a large majority of satellites have such equipment, the docking device makes it possible to dock to most satellites even if they do not have equipment dedicated to docking to a towing or refueling craft.

In addition, the design of the docking device, comprising two platforms linked together by articulated arms equipped with magnetic dampers, the articulated arms allowing six degrees of freedom for the satellite receiving platform, makes it possible to ensure an initial contact where the forces on the satellite are less than a few Newtons, and a viscous damping of the contact energy which allows obtaining, at the end of damping, a zero relative speed between the satellite and the spacecraft.

The capture member of the docking device makes it possible to prevent a possible distancing or rebound of the satellite relative to the docking device during the dissipation phase, while achieving an alignment of the satellite relative to the docking device, making it possible to then lock the satellite in a rigid connection with the docking device.

The docking device also makes it possible to release the satellite while moving the towing or refueling craft away from it, which makes it possible to avoid any unwanted contact or forces on the satellite at the time of release.

### BRIEF DESCRIPTION OF DRAWINGS

Other features, details, and advantages will become apparent upon reading the detailed description below, and upon analyzing the appended drawings, in which:

FIG. 1 shows an example of a docking device according to one embodiment.

FIG. 2 shows a device for damping and positioning, of a docking device.

FIG. 3a shows an example of a capture device of a docking device.

FIG. 3b is a detail view of part a capture device.

FIG. 4 schematically represents an example of a locking device of a docking device.

FIG. 5a schematically represents a contact phase of a docking method according to one embodiment.

FIG. 5b schematically represents a damping and capture phase of a docking method.

FIG. 5c schematically represents a phase of adjusting the position of the captured satellite.

FIG. 5d schematically represents a phase of locking the captured satellite.

FIG. 6a schematically represents a distancing phase during a satellite undocking method.

FIG. 6b schematically represents a separation phase during a satellite undocking method.

FIG. 6c schematically represents a phase of retracting the satellite receiving platform.

FIG. 7 schematically represents the main steps of a method for docking and undocking a spacecraft for towing or refueling a satellite.

### DESCRIPTION OF EMBODIMENTS

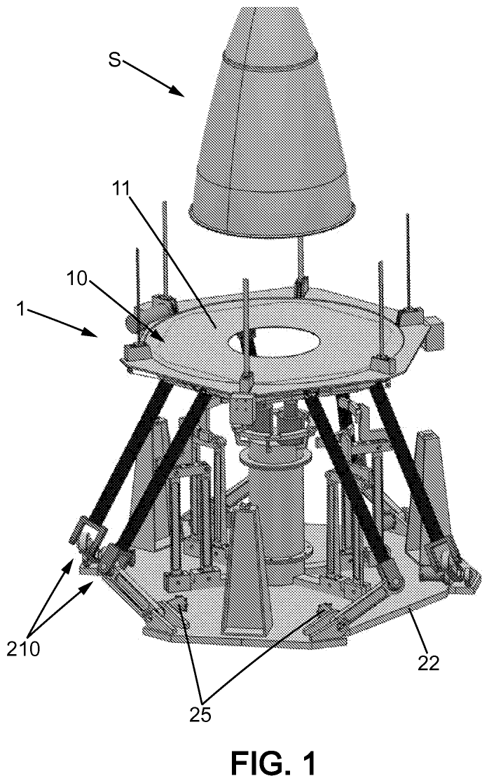

Reference is now made to FIG. 1, which shows an example of a docking device 1 in a phase of approaching a satellite 2. The docking device 1 is suitable for docking to a satellite which possibly may not have any equipment specifically provided for this purpose, but comprises a protruding element S, such as a nozzle of a liquid apogee engine (conventionally designated by the acronym LAE), or a launcher interface ring (conventionally designated by the acronym LIR). The protruding element S has a substantially circular or annular shape. In the figures, the examples represented show the case where the protruding element S is a nozzle of a liquid apogee engine.

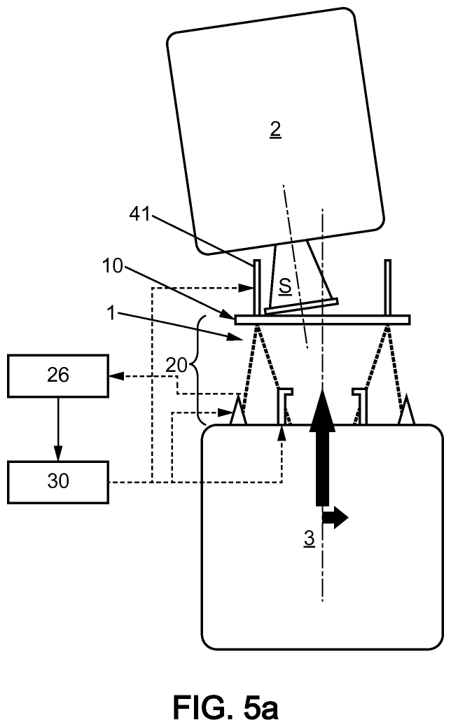

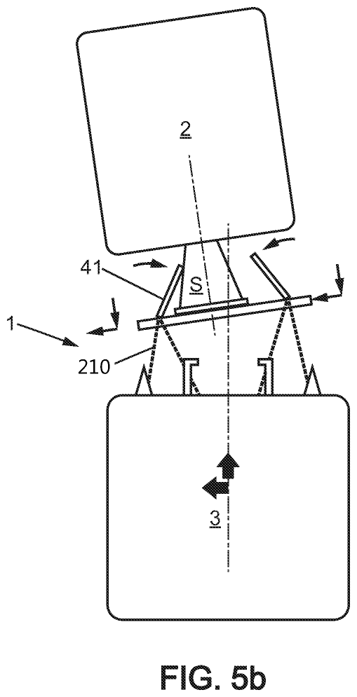

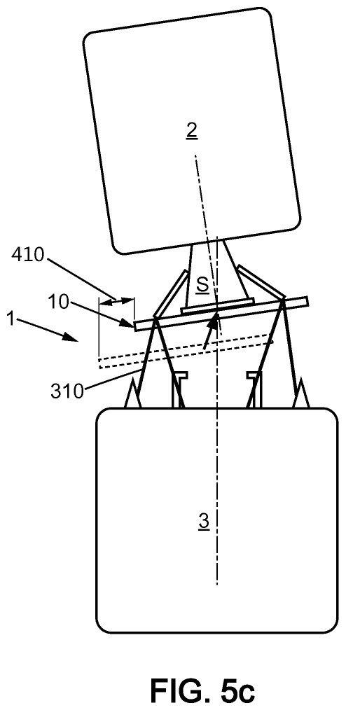

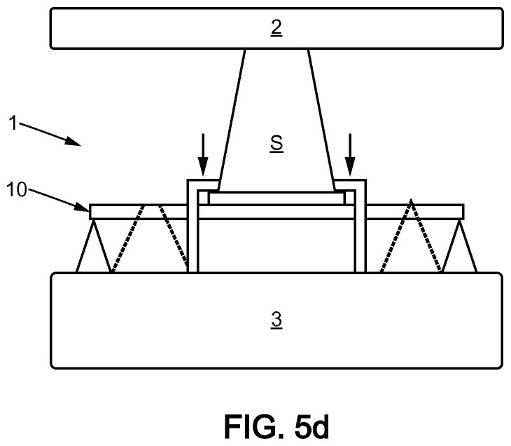

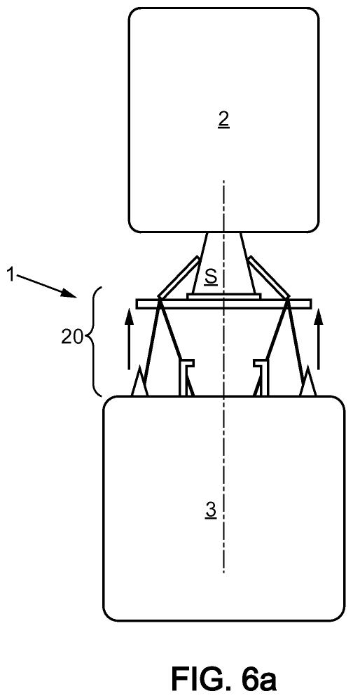

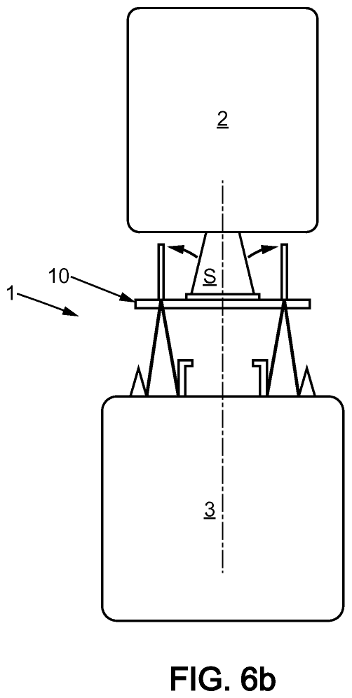

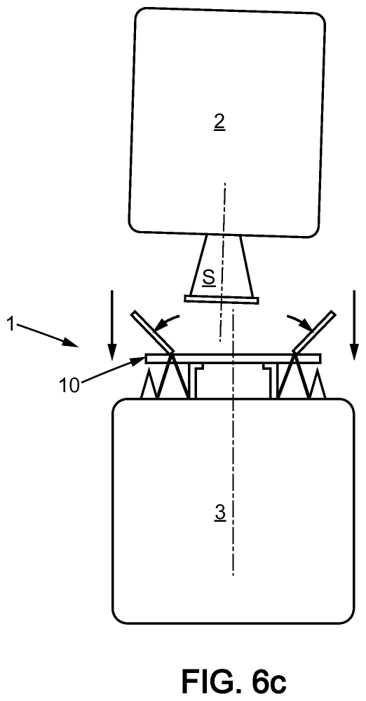

As for the docking device 1, it is mounted on a towing or refueling spacecraft 3, schematically represented in FIGS. 5a to 5d and 6a to 6c. For example, the docking device 1 may be mounted on an external wall of such a craft.

Referring to FIG. 1, the docking device 1 comprises a mobile receiving platform 10 for a satellite, suitable for receiving and bearing against the protruding element of the satellite. To allow this, the receiving platform 10 is flat and has a substantially circular or polygonal shape. The receiving platform comprises a receiving area 11 of circular or annular shape, of which the diameter is strictly greater than the external diameter of the protruding element against which it comes to bear. Advantageously, the radius of the receiving area 11 is equal to the radius of the protruding element, plus a margin which allows adjusting for positioning deviations, this margin advantageously being between 50 mm and 200 mm, for example equal to 100 mm.

The satellite receiving platform 10 is movable relative to the spacecraft 3 on which the docking device is mounted. Indeed, during the craft's approach towards the satellite, there may be misalignments between the position of the receiving platform 10 and the end section of the protruding element which is to come into contact with the platform. These misalignments may be translational and/or rotational. Consequently, the receiving platform must be movable in at least five degrees of freedom relative to the spacecraft 3, namely three degrees of freedom in translation and two degrees in rotation, the only rotation not affecting the relative position between the platform and the satellite being a rotation about an axis on which the platform is centered. In one embodiment, the receiving platform is movable in six degrees of freedom, three of them rotational, which allow dampening any torsion from relative differences in rotational speed between the satellite and the spacecraft 3, transmitted by friction between the satellite and the receiving platform at the moment of contact.

These degrees of freedom also make it possible, as detailed below, to dampen the contact between the satellite and the receiving platform 10.

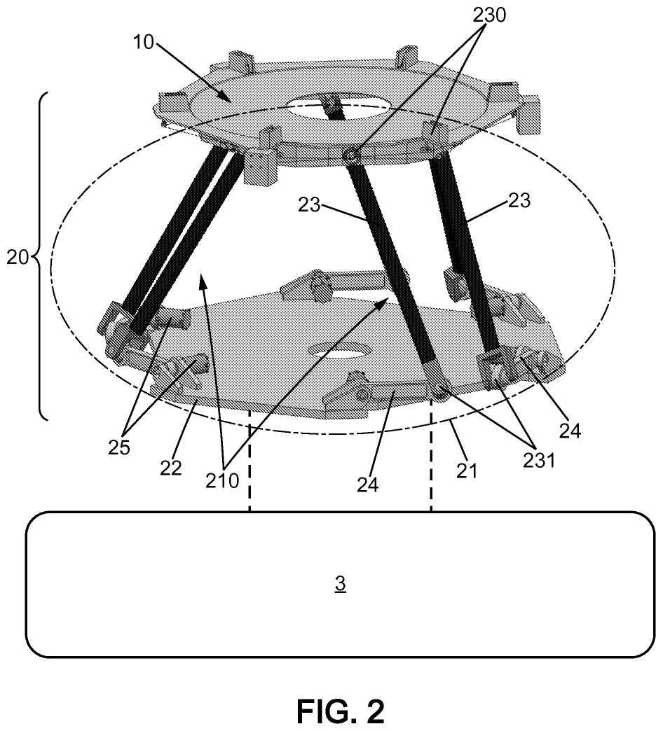

To achieve mobility of the platform 10 and damping of the contact between the satellite and the platform, the docking device 1 comprises a device 20 for damping and positioning the receiving platform 10, this device 20 also being represented in FIG. 2.

This device 20 comprises a set 21 of link arms 210, connected at one end to the receiving platform 10 and at the other end to a member that is fixed relative to the spacecraft. This fixed member may be a wall of the spacecraft 3. Alternatively, and as shown in FIG. 2, the device 20 for damping and positioning further comprises a platform 22 for connecting to the spacecraft 3, suitable for attachment to a wall of the spacecraft and forming the fixed member to which the articulated arms 210 are connected. This platform is flat and has a circular or polygonal shape, with dimensions that are preferably greater than or equal to those of the receiving platform 10 for the satellite.

To allow the movements of the receiving platform 10, the set 21 preferably comprises six link arms 210, in order to simplify controlling the position of the platform. Each link arm comprises a first end connected to the satellite receiving platform 10 by a spherical connection 230, advantageously achieved by a universal joint.

In addition, to allow a variation in distance between the receiving platform 10 and the connecting platform 22 without using a sliding connection, which can cause friction and premature wear of parts in space, each arm 210 is articulated. In this respect the arm comprises a first rod 23 and a second rod 24, the rods being straight and rigid. The first rod 23 is connected to the receiving platform 10 by the spherical connection 230, and to the second rod 24 by a second spherical connection 231. As for the second rod 24, it is mounted so as to rotate relative to the fixed member, for example the connecting platform 22, about a single axis.

Advantageously, the arms 210 are distributed in a circular arrangement, meaning that the ends of the arms at the satellite receiving platform are regularly distributed in a circular arrangement, this circle being close to the edge of the receiving platform in order to form a more significant lever arm. Similarly, the ends of the arms at the connecting platform are regularly distributed in a circular arrangement of a diameter greater than or equal to the diameter formed by the arm ends located at the receiving platform.

As will be understood in FIGS. 1 and 2, the connecting platform 22 is advantageously mounted to the towing or refueling spacecraft 3 at a non-zero distance from it. Also, the axes of rotation of the second rod 24 of each arm 210 and the shape of the connecting platform 22 are advantageously suitable for allowing each arm 210 to adopt a position in which the connection 231 between the two rods is at a smaller distance from the spacecraft 3 than the connecting platform. For example, the axes of rotation of the second rod of each arm are advantageously arranged radially, with a pivot point located at the edge of the connecting platform, so that the second rod can pivot about its axis without being blocked by the platform, which allows providing longer travel for the damping and positioning.

Alternatively, the connecting platform 22 may have, for each arm 210, a through-notch allowing part of the arm to be housed therein at the end of its travel.

According to yet another variant, the axes of rotation of the second rods of each arm may be tangential to the edge of the connecting platform 22.

The device for damping and positioning further comprises a set of magnetic dampers 25 allowing an equivalent viscous damping of the contact between the satellite and the receiving platform 20, meaning proportional to the relative speed between the satellite and the receiving platform 20 at the moment of contact.

In this respect, the set of magnetic dampers comprises a rotary magnetic damper 25 for each articulated arm 210. Each magnetic damper is advantageously positioned at the base of each arm 210, being connected to the second rod 24 of each arm, so as to dampen the rotational movement of the second rod relative to the connecting platform 22. In this respect, each damper 25 comprises a rotor and a stator (these are not shown). The stator is fixedly mounted relative to the towing or refueling spacecraft 3, for example mounted on the connection platform 22. The rotor is rotatably mounted relative to the stator so as to rotate about the same axis of rotation as that of the second rod 24 of the arm in question, and advantageously the second rod of each arm is suitable for driving the rotation of the rotor of the corresponding damper.

In one embodiment, each damper further comprises a reduction gear (not shown) suitable for multiplying the speed of rotation of the rotor, induced by that of the second rod of the corresponding arm, by a factor greater than or equal to 10, for example equal to 20.

Each damper can therefore achieve viscous dissipation, via eddy currents, of the rotation of the second rod of the corresponding arm, this rotation itself being induced by the movement of the receiving platform 20.

The device 20 for damping and positioning the receiving platform 10 also makes it possible to control the position of this platform 10. To do this, it advantageously comprises a position sensor 26 (schematically represented in FIG. 5a) for each link arm. The sensor may be a sensor for sensing the angular position of the second rod of each arm.

In addition, each magnetic damper 25 may advantageously be controlled according to several modes, comprising at least:
a damper mode, in which movement of the link arm (in the embodiment where the link arms are articulated arms, the movement is a rotation of the second rod about its axis) causes dissipation, by circulation of eddy currents, and
an actuator mode, in which the damper is controlled so as to cause movement of the link arm (in the embodiment where the link arms are articulated, the controlled movement is a rotation of the second rod about its axis).

In one embodiment, each magnetic damper 25 may further be controlled according to an additional mode called free mode, where the link arm can move freely without causing any damping by the damper.

In one embodiment, control of the mode is enabled by control electronics 30 making it possible to selectively:
place each damper in short circuit in order to set it in damper mode,
supply voltage to each damper in order to control it in actuator mode, and
place each damper in open circuit in order to set it in free mode.

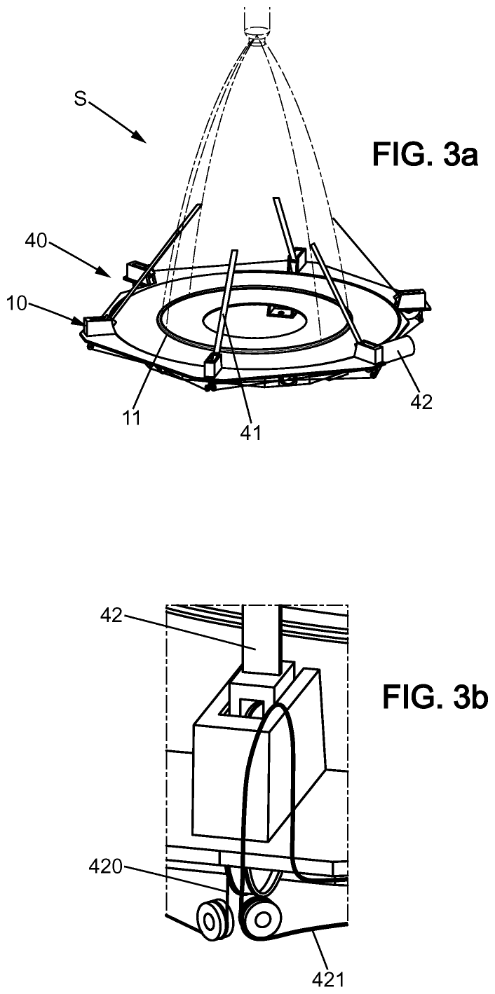

With reference to FIGS. 1 and 3a, the docking device further comprises a capture device 40 for capturing the protruding element of the satellite, the capture device 40 being suitable for keeping the satellite resting against the satellite receiving platform 10, in particular so as to avoid rebound of the satellite and docking device.

The capture device 40 comprises a set of retaining rods 41, mounted on the receiving platform 10 and movable relative to said platform, the retaining rods 41 being shaped to allow bearing on the protruding element of the satellite at six bearing points, in order to prevent relative movement of the protruding element of the satellite with respect to the receiving platform 10, in six degrees of freedom.

In this regard, according to a first embodiment, the capture device 40 may comprise three retaining rods arranged regularly on the circumference of the receiving platform 10, where each retaining rod has an end formed of a circular arc providing two bearing points. Alternatively, and as shown in the figures, the capture device may comprise six retaining rods 41 regularly distributed in a circular arrangement, outside the receiving area 11 for the protruding element, therefore close to the edge of the receiving platform 10.

The retaining rods have a length suitable for bearing against the protruding element, while taking into account the size of the receiving area 11 of the platform and any differences in the sizes of the protruding elements S of the satellites for which the capture device 40 is designed.

Each rod 41 is rotatable about an axis enabling the rods to be tilted towards the center of the connecting platform, this axis therefore being tangential to the circle on which the rods are arranged. In addition, the capture device 40 comprises an actuator 42 for the rods. Referring to FIG. 3b, in one embodiment there is a single actuator 42, and each rod is driven in rotation by a double pulley 420 connected to the two adjacent rods 41 by belts 421. As a result, a single actuator 42 allows simultaneous transmission of movement to all the rods in order to fold them down towards the center of the landing platform or move them away from it.

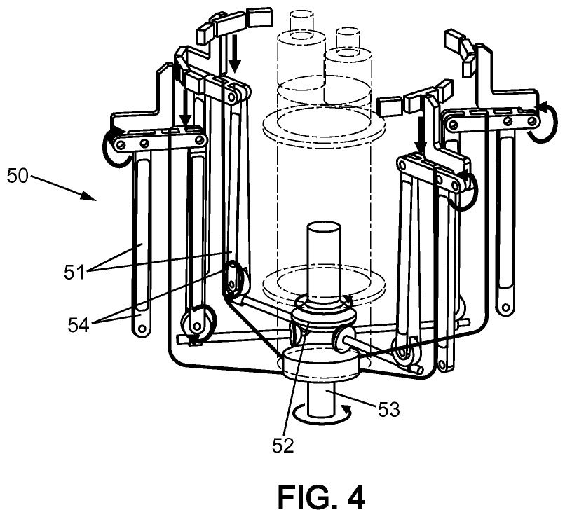

Referring to FIG. 4, the docking device 1 may also comprise a locking device 50 suitable for establishing and maintaining a rigid connection between the docking device and the protruding element of the satellite, and therefore between the towing or refueling spacecraft and the satellite. This locking device 50 advantageously comprises two degrees of movement in order to be able to lock different sizes of protruding elements S of satellites, comprising a degree of radial translational movement in a plane parallel to the plane of the connecting platform, enabling gripping elements to adapt to different diameters of a protruding element S and to come into contact therewith, and a degree of axial translational movement along an axis perpendicular to the plane of the connecting platform, in order to apply a force on the protruding element in order to keep it resting against the receiving platform.

In the embodiment shown in FIG. 4, these degrees of movement are achieved by angled retaining members 51 suitable for bearing against the protruding element of the satellite once placed on the receiving platform, then for exerting on a peripheral edge of this element a force directed towards the connecting platform so as to keep the protruding element S of the satellite resting on the receiving platform 10.

In the example of FIG. 4, four retaining members 51 are regularly distributed around a central axis of the connecting platform, and can be driven to rotate towards this central axis by one or more actuators 52. The force directed towards the connecting platform may be implemented by another actuator 53, for example by means of other pulleys 54. In this case, the satellite receiving platform 10 advantageously comprises one or more orifices provided to allow the passage of retaining members.

Alternatively, the locking device may be carried by the towing or refueling spacecraft, independently of the docking device.

Finally, the docking device 1 also comprises at least one computer suitable for controlling the various components of the docking device, namely: the device for damping and positioning the satellite receiving platform 10, the capture device, and where applicable the locking device. The computer may be combined with the control electronics 30 of the dampers, mentioned above.

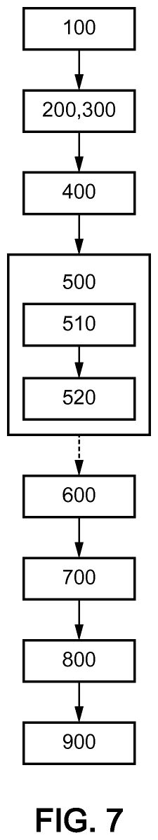

More specifically, the computer 30 (see also FIG. 5a) is suitable for controlling these components in order to implement a method for docking and a method for undocking, described below. The method for docking is described with reference to FIGS. 5a to 5d, and 7.

It comprises a first step 100 of moving the towing or refueling spacecraft to approach the satellite. This approach is advantageously carried out at a low relative speed, for example between 5 and 20 mm/s. Referring to FIG. 5a, this approach continues until first contact of the protruding element of the satellite on the receiving platform 10 of the docking device. During this approach, the satellite receiving platform may be positioned at a predetermined distance from the connecting platform, in order to anticipate a reduction in distance between the platforms, related to the contact of the receiving platform with the satellite.

Referring to FIG. 5b, the method then comprises a step 200 of damping the impact by viscous dissipation. During this step, the magnetic dampers 25 are controlled in damper mode. The receiving platform 10 then adjusts for errors in position and orientation between the satellite and the spacecraft 3. The structure of the damping device 20 and the nature of the viscous damping allowed by the dampers make it possible to overcome the very low mechanical stiffness at the satellite in order to avoid a rebound phenomenon, and make it possible to induce very low contact forces on the satellite, i.e. less than a few Newtons. The relative speed between the satellite and the platform is brought to zero by the end of the damping step 200, which lasts several tens of seconds.

During the damping phase 200, a step 300 of capturing the protruding element S of the satellite also takes place, carried out by actuating the capture device 40 in order to fold the retaining rods 41 against the protruding element of the satellite. This also helps to prevent any rebound of the satellite. The force exerted by the retaining rods against the protruding element of the satellite here again is less than a few Newtons, even less than one Newton, which makes it possible to avoid affecting the position or orientation of the satellite. In one embodiment, at the end of the damping and capture, the control of the dampers can switch to free mode in order to minimize the effects on the satellite.

With reference to FIG. 5c, the method then comprises, once the damping and capture have been completed, a step 400 of adjusting the relative positioning of the satellite with respect to the docking device, without affecting the satellite's attitude. During this step, the dampers are controlled in actuator mode, so as to control the link arms in order to orient the receiving platform and the satellite assembled thereto, to a desired position. This step makes it possible in particular to bring the satellite to a reference position where the axis of the protruding element (LAE or launcher interface ring) is parallel, or even coincident, with the axis on which the receiving platform 10 is centered and the axis on which the connecting platform is centered.

In one embodiment, step 400 is subdivided into several successive movements comprising a first movement 410 of pure translation of the receiving platform 10, in order to center the platform relative to the docking device. This is the movement shown in the example of FIG. 4c, where the center of the receiving platform 10 is aligned with a center axis of the docking device, represented with dotted lines in the figure.

A second movement 420 of pure rotation then takes place, in order to bring the axis of the protruding element of the satellite to be coincident with the axis of the docking device, or in other words to bring the receiving platform 10 to be parallel to the support of the docking device on the spacecraft, or parallel to the connecting platform. During this second movement, the spacecraft is controlled simultaneously with the movement of the dampers used as actuators of the docking device, and in an opposing movement, in order to adjust the towing or refueling spacecraft to the attitude of the satellite, without modifying said attitude.

Finally, the orientation 400 of the receiving platform comprises a third movement 430 of pure translation in the direction of the axis of the spacecraft, which is also that of the satellite, and which corresponds to the vertical direction in the figures, in order to return the connecting platform to the reference position.

Finally, with reference to FIG. 5d, the method comprises a step 500 of locking the connection between the satellite and the docking device—and therefore between the satellite and the spacecraft 3—which comprises a sub-step 510 during which the receiving platform 10 is brought closer to the connecting platform, and a sub-step 520 during which a locking device engages with the protruding element of the satellite to immobilize it and form a rigid connection. If necessary, during this stage the dampers can be switched to free mode or to damping mode so as to accommodate any force induced from movement during locking. As the damping is proportional to the speed and the speed is low, damping mode can be considered.

With reference to FIGS. 6a to 6c and 7, once the desired operations have been carried out, a method for undocking the towing or refueling spacecraft from the satellite can be implemented.

This method advantageously comprises a first step 600 during which the locking device is disengaged from the protruding element of the satellite, while keeping the capture device closed on the protruding element.

Referring to FIG. 6a, the method then comprises a step 700 of moving the satellite receiving platform 10 by the link arms in order to move it away from the connecting platform. To do this, the dampers are controlled in actuator mode. The capture device still remains closed on the protruding element of the satellite.

Referring to FIG. 6b, the method then comprises a step 800 of releasing the satellite, by opening the capture device.

Finally, with reference to FIG. 6c, the method comprises a step 900 of bringing the receiving platform 10 closer to the connecting platform, so as not to interfere with the movement away from the satellite. For the same reason, the opening of the capture device continues, in order to distance the retaining rods as much as possible from the protruding element of the satellite.

This method for undocking makes it possible to release the satellite at a certain distance from the spacecraft 3, and to ensure that during undocking no force is exerted on the satellite. Thus, for the method for docking as well as for the method for undocking, the position of the satellite is not affected by the docking device 1.

Advantageously, the docking device as well as the spacecraft 3 are controlled from a ground station, and in this respect comprise a communication interface (not shown) for communicating with the station.

1. A docking device for docking to a satellite, wherein the satellite comprises an external wall and a protruding element protruding from the external wall, wherein the docking device is configure to be mounted on a towing or refueling spacecraft, and the docking device comprises:
a satellite receiving platform configured to rest against the protruding element of the satellite,
a capture device configured to capture the protruding element of the satellite and configured to keep the protruding element in contact with the satellite receiving platform, and
a device configured to dampen and position the satellite receiving platform and the device comprising:
a set of link arms connecting the satellite receiving platform to a member fixed relative to the spacecraft, the set of link arms configured to enable the satellite receiving platform to move in six degrees of freedom relative to the spacecraft, and
a set of magnetic dampers configured to dampen contact between the satellite and the satellite receiving platform in proportion to a relative speed between the satellite and the satellite receiving platform.

2. The docking device according to claim 1, wherein each of the link arms is articulated, and the set of magnetic dampers comprises a rotatable magnetic damper for each of the link arms.

3. The docking device according to claim 2, wherein each of the link arms comprises a first rod including a first end connected to the satellite receiving platform by a first spherical connection, and a second end connected to the second rod by a second spherical connection, wherein the second rod is rotatable relative to the spacecraft about an axis.

4. The docking device according to claim 3, wherein each of the magnetic dampers comprises a stator fixedly mounted relative to the spacecraft, and a rotor rotatable relative to the stator, and the second rod of each of the link arms is configured to rotate the rotor of the magnetic damper corresponding to the link arm.

5. The docketing device according to claim 4, wherein the second rod rotates the rotor of the magnetic damper via a reduction gear configured to multiply a speed of rotation of the second rod relative to the stator of the magnetic damper by a factor greater than 10.

6. The docketing device according to claim 2, further comprising, for each of the link arms, a sensor configured to sense the angular position of the second portion of the link arm.

7. The device according to claim 2, wherein the rotary magnetic dampers are distributed in a circular arrangement, and axes of rotation of the dampers extend radially.

8. The docketing device according to claim 1, further comprising an electronic circuit configured to control the magnetic dampers in modes comprising:
a damper mode, in which movement of the link arm is damped by dissipation of kinetic energy via eddy current,
an actuator mode in which an actuator controls, movement of the link arm, and
a free mode, in which movement of the link arm does not cause any damping.

9. The docketing device according to claim 1, wherein the device configured for damping and positioning the satellite receiving platform further comprises a connecting platform configured to connect to the spacecraft and configured to be assembled to said craft, and the set of link arms connect the satellite receiving platform to the connecting platform.

10. The docking device according to claim 1, wherein the capture device comprises retaining rods mounted on the satellite receiving platform, and comprising six bearing points on the protruding element of the satellite, and an actuator configured to bring the bearing points of the set of retaining rods to bear against the protruding element of the satellite.

11. The docketing device according to claim 1, wherein the retaining rods comprise six rods distributed circularly around the periphery of the satellite receiving platform, each of the retaining rods is mounted to rotate about a tangential axis, and the actuator comprises an actuation system including pulleys and belts configured to enable simultaneous rotation of the retaining rods towards the center of the satellite receiving platform.

12. The docketing device according to claim 1, further comprising a locking device configured to maintain a rigid connection between the docking device and the protruding element of the satellite.

13. A method for docking a towing or refueling spacecraft including a docking device to a satellite comprising a protruding element the method comprising:
moving the towing or refueling spacecraft towards the satellite such that the satellite receiving platform is positioned substantially opposite the protruding element,
establishing contact between the protruding element of the satellite and the satellite receiving platform,
damping kinetic energy from the contact by a device for damping and positioning the satellite receiving platform,
during the damping, capturing the protruding element of the satellite,
once the damping is complete, adjusting a relative position of the satellite and the towing or refueling spacecraft, and
locking a connection between the satellite and the towing or refueling spacecraft.

14. The method of claim 13, further comprising:
unlocking the connection between the second satellite and the towing or refueling spacecraft,
moving the satellite receiving platform using the device for damping and positioning to move the receiving platform away from the connecting platform,
actuating the capture device to release the satellite, and
retracting the satellite receiving platform the device for damping and positioning to bring the satellite receiving platform closer to the connecting platform.

15. A method for controlling a towing or refueling spacecraft (3) from a ground station, in order to implement the method for docking in orbit according to claim 13.
